(19) United States
(12) Patent Application Publication
(10) Pub. No.: US 2013/0176262 A1
(43) Pub. Date: Jul. 11, 2013

(54) PROJECTED CAPACITIVE TOUCH PANEL

(71) Applicant: JIH-MING HSU, Hsinchu City (TW)

(72) Inventor: JIH-MING HSU, Hsinchu City (TW)

(73) Assignee: Silicon Integrated Systems Corp., Hsinchu City (TW)

(21) Appl. No.: 13/343,861

(22) Filed: Jan. 5, 2012

(51) Int. Cl. G06F 3/045

(52) U.S. Cl. 345/174

(57) ABSTRACT

A projected capacitive touch panel has a plurality of bar shaped first electrodes arranged parallel to each other and a plurality of wiggly-shaped second electrodes separated from each other by a space and each including a plurality of sensing lines. The sensing lines of each second electrode are spaced from each other by an interval, electrically connected to each other and extend along an oriented direction perpendicular to the length direction of the first electrodes in a wiggly manner. The sensing lines that are separated from each other by a short interval improve touch sensing effect.

### FIELD OF THE INVENTION

The present invention relates to a touch panel, especially to a projected capacitive touch panel that increases touch-sensing accuracy.

### BACKGROUND OF THE INVENTION

A projected capacitive touch panel usually includes two sets of transparent electrodes (X and Y) disposed on two different substrates or a single substrate and a plurality of driving wires that are connected to the electrodes.

With reference to FIG. 1, a conventional projective capacitive touch panel includes a set of X electrodes X1 to X4 and another set of Y electrodes Y1 to Y4 perpendicular to the X electrodes X1 to X4. The X and the Y electrodes are used to be connected to a control circuit through a plurality of driving wires and thereby construct a sensor array. The control circuit can sense a change in capacitance between the X and the Y electrodes to determine the position or location of a touch by a user.

Each of the X and the Y electrodes is usually straight bar-shaped or constructed by a series of diamond-shaped segments connected together. When being straight bar-shaped, the X electrodes on a lower substrate will be arranged to nearly fully cover the touch-sensing area so that the touch panel can be insulated against the interference occurred from a liquid crystal device when the touch panel is mounted on the liquid crystal device. The Y electrodes on an upper substrate may be arranged to cover the touch-sensing area by a sensing area coverage ratio of 20% to 25% so as NOT to shield the magnetic lines of force between the X and the Y electrodes (that is, not to disable the touch-sensing function). However, maintaining such coverage ratio will leave a large distance between the adjacent electrodes and thereby decrease the touch-sensing effect. If the user's finger is small or the user uses a touch-screen stylus, the electrodes near the touch point may not sense the change in capacitance and the control circuit is not able to calculate the actual touch position by interpolating and thereby sense the touch inaccurately. With the styluses getting thinner, this shortcoming will become a serious problem.

To overcome the shortcomings, the present invention provides a projected capacitive touch panel to mitigate or obviate the aforementioned problems.

### SUMMARY OF THE INVENTION

The main objective of the invention is to provide a projected capacitive touch panel that increases touch-sensing accuracy.

The projected capacitive touch panel of the present invention comprises a plurality of bar shaped first electrodes arranged parallel to each other and a plurality of wiggly-shaped second electrodes separated from each other by a space and including a plurality of sensing lines. The sensing lines of each second electrode are spaced from each other by an interval, electrically connected to each other and extend along an oriented direction perpendicular to the length direction of the first electrodes in a wiggly manner.

Since each second electrode is constructed by the sensing lines that are separated from each other by a relatively short interval, the distance left between adjacent electrodes is relatively shorter and thereby provide a much greater touch sensing effect.

Other objectives, advantages and novel features of the invention will become more apparent from the following detailed description when taken in conjunction with the accompanying drawings.

### BRIEF DESCRIPTION OF THE DRAWINGS

FIG. 1 is a top view of the arrangement of the electrodes of a conventional projected capacitive touch panel;

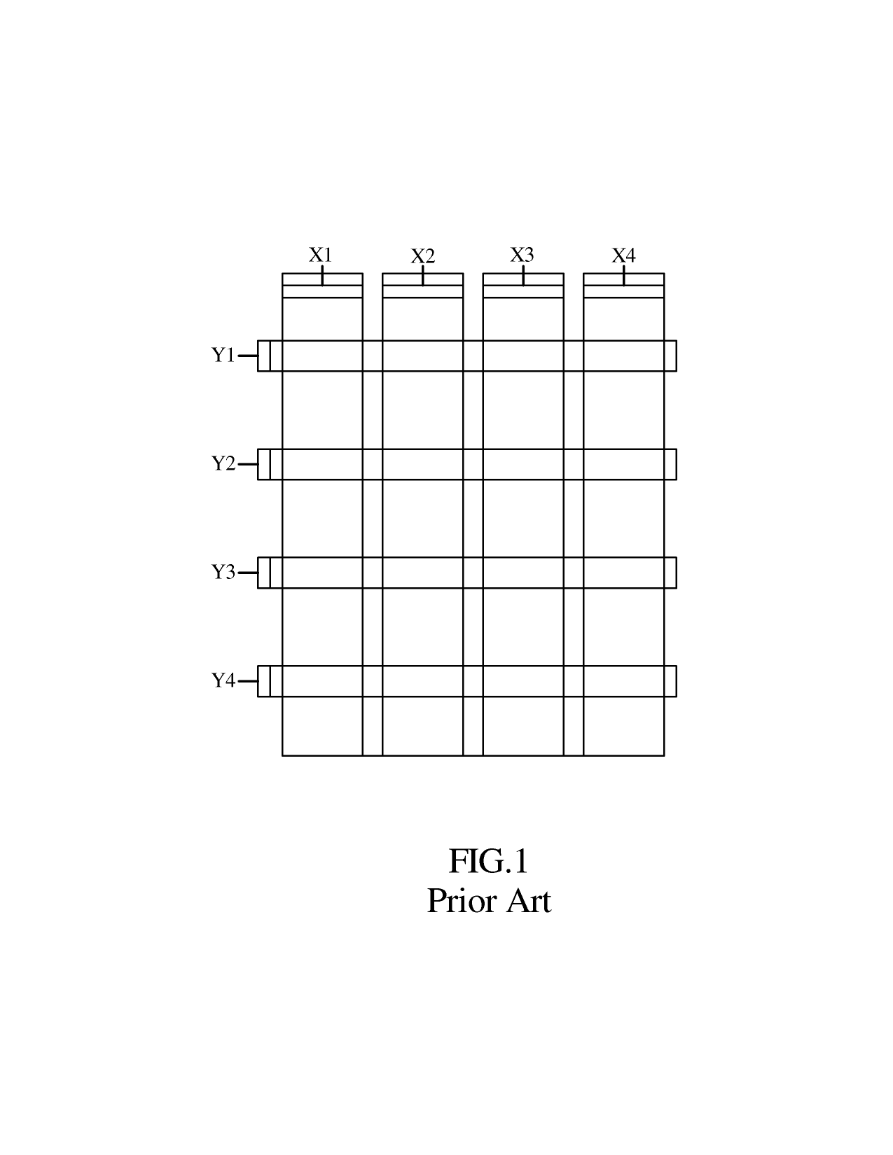

FIG. 2 is a top view of a first embodiment of the arrangement of the electrodes of a projected capacitive touch panel in accordance with the present invention;

FIG. 3 is a perspective view of an embodiment of the projected capacitive touch panel in accordance with the present invention;

FIG. 4 is a partial enlarged view of one embodiment of the electrodes in FIG. 2;

FIG. 5 is a partial enlarged view of another embodiment of the electrodes in FIG. 2; and

FIG. 6 is a top view of a second embodiment of the arrangement of the electrodes of the projected capacitive touch panel in accordance with the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

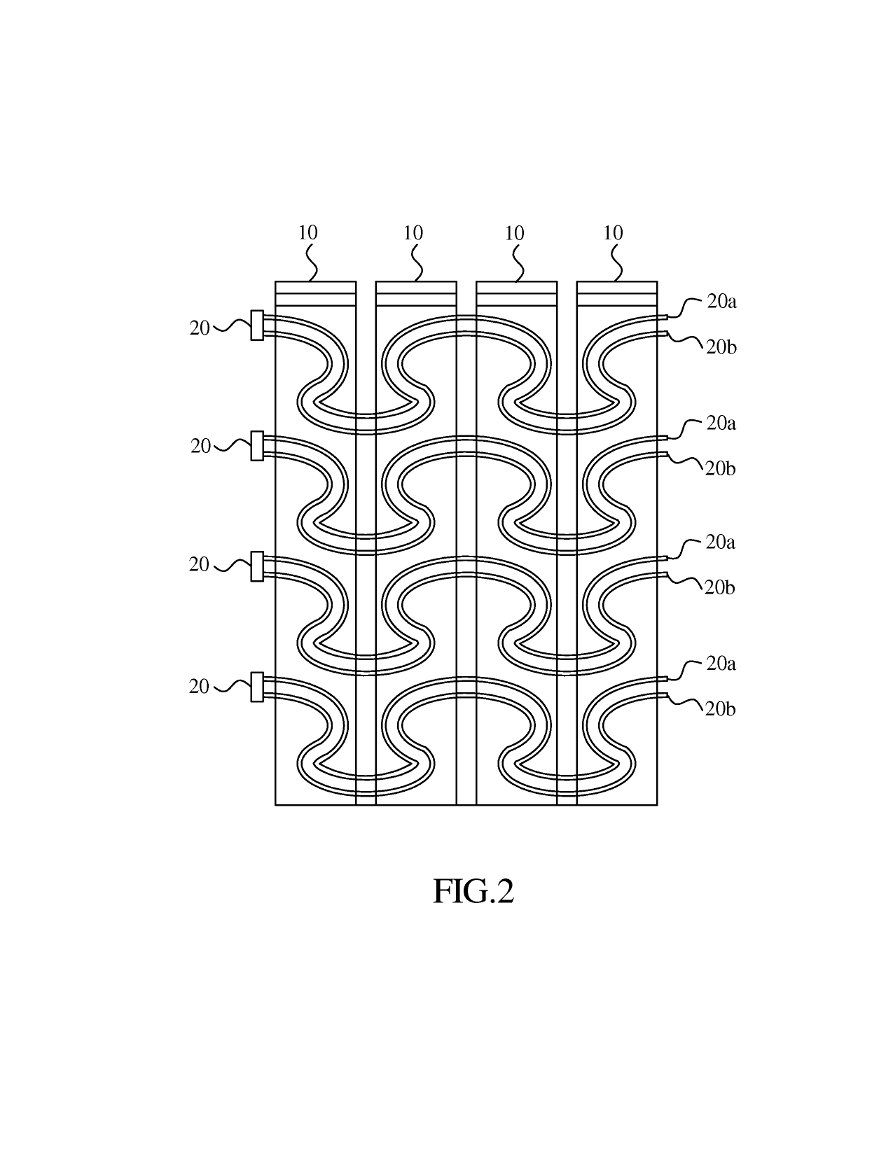

With reference to FIG. 2, a projected capacitive touch panel comprises a plurality of first electrodes 10 and a plurality of second electrodes 20 being crossed the first electrodes 10. The first electrodes 10 and the second electrodes 20 are arranged to define a sensing area and are used to be connected to a plurality of driving wires of a control circuit, respectively. When the electrodes are driven by electricity, mutual capacitance occurs at the intersections of the first and the electrodes 10, 20. The first electrodes 10 and the second electrodes 20 are preferably formed from a transparent conductive material, such as ITO (Indium Tin Oxide).

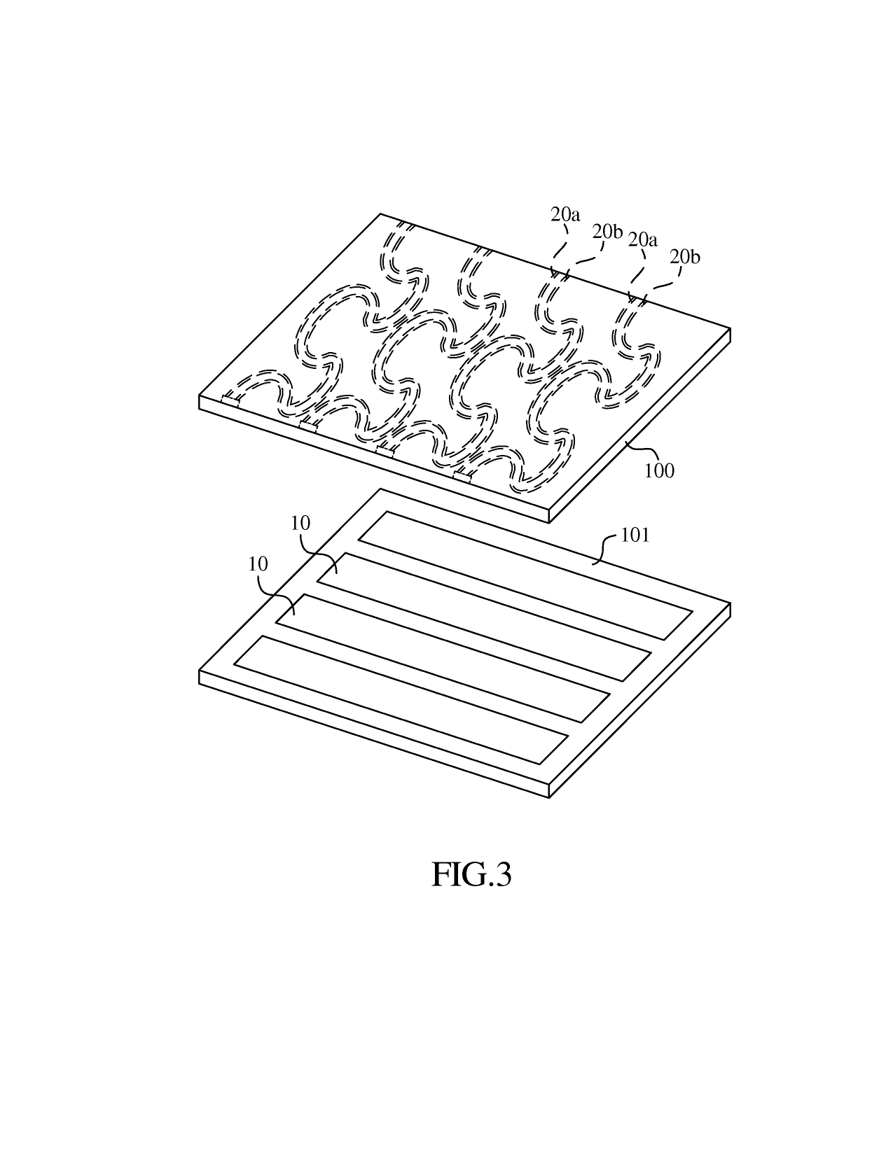

The first electrodes 10 are straight bar-shaped, arranged parallel to each other. The first electrodes 10 preferably nearly fully cover the sensing area. And further reference to FIG. 3, the first electrodes 10 may be disposed on a top surface of a first substrate 101.

The second electrodes 20 are wiggly-shaped, separated from each other by a space. And further reference to FIG. 3, the first electrodes 10 may be disposed on a bottom surface of a second substrate 100. The second substrate 100 is opposite to the first substrate 101. Each second electrode 20 includes a plurality of sensing lines 20a, 20b. The sensing lines 20a, 20b of one second electrode 20 are spaced from each other by an interval, electrically connected to each other and extend along an oriented direction perpendicular to the length direction of the first electrodes 10 in a wiggly manner. As shown in FIG. 2, the sensing lines 20a, 20b of each second electrode 20 is connected to each other at an end. In some other implementations, the sensing lines 20a, 20b may be connected to each other with multiple conjunctions so as to facilitate reducing resistance of the electrode set 20. Besides, the sensing lines 20a, 20b of all of the second electrodes 20 preferably have a sensing-area coverage ratio of 20% to 25%.

To have a sensing-area coverage ratio of 20% to 25% the same with the prior art, the number of the sensing lines 20a, 20b is relatively larger and the width of each sensing line is thinner than the conventional electrodes mentioned in the prior art. A distance left between the adjacent sensing lines 20a, 20b will be shorter than the distance between the adjacent conventional electrodes mentioned in the prior art and thereby the touch-sensing effect can be improved due to the reduced distance between adjacent sensing lines.

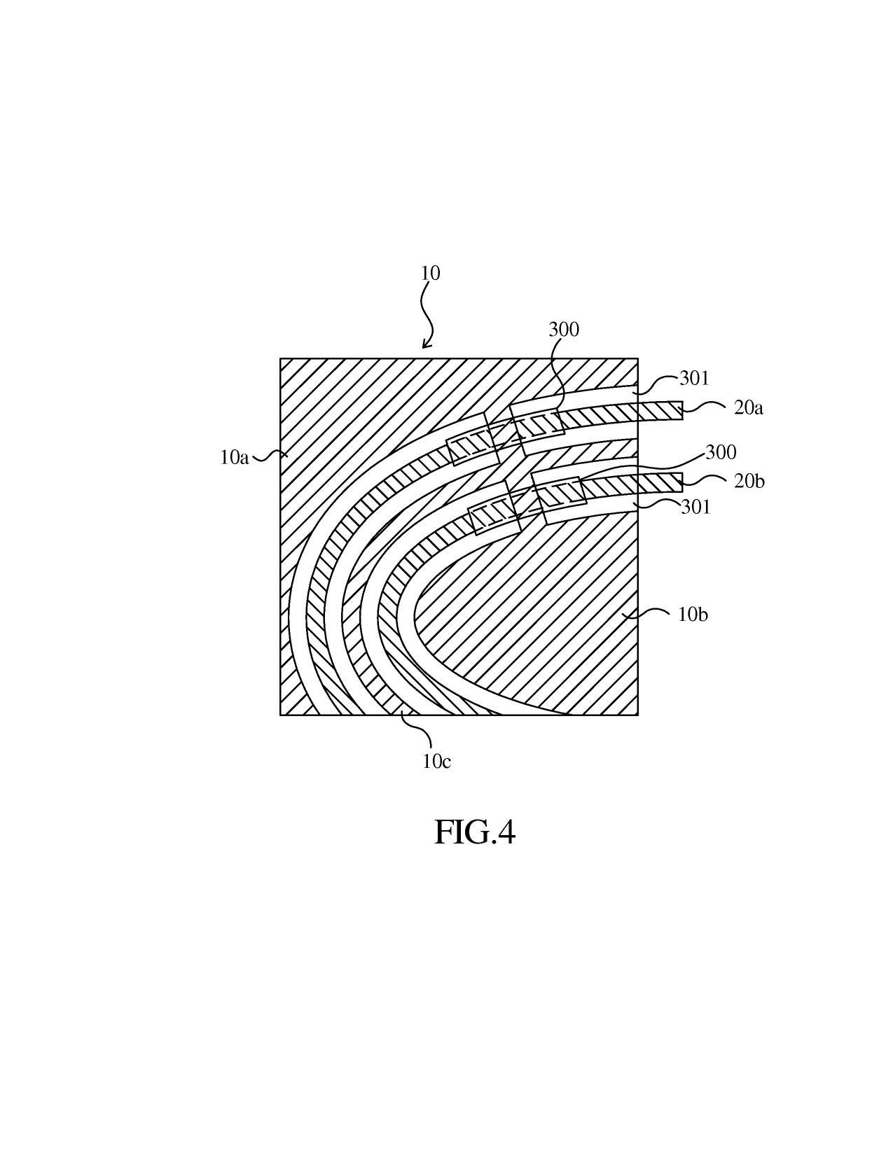

Besides being respectively formed on two different substrates, in another embodiment, the first and the second electrodes 10, 20 may be formed together on a surface of a single substrate. With reference to FIG. 4, when being formed on the same surface of a substrate (not shown), the first electrode 10 has a plurality of separated portions 10a, 10b, 10c that are separated by gaps 301, and the sensing lines 20a, 20b of the second electrodes 20 are formed in the gaps 301 between the adjacent separated portions 10a, 10b, 10c of the first electrodes 10. The separated portions 10a, 10b, 10c are connected to each other by insulatedly crossing the sensing lines 20a, 20b. Preferably, the projected capacitive touch panel further comprises a plurality of bridge members 300 formed in the gaps 301 at the crossover position where the separated portions 10a, 10b, 10c cross the sensing lines 20a, 20b so as to prevent the first electrodes 10 to be electrically conducted to the sensing lines 20a, 20b. In other words, the separated portions 10a, 10b, 10c of each of the first electrodes 10 are connected together by crossing the sensing lines 20a, 20b with the bridge members 300 formed therebetween.

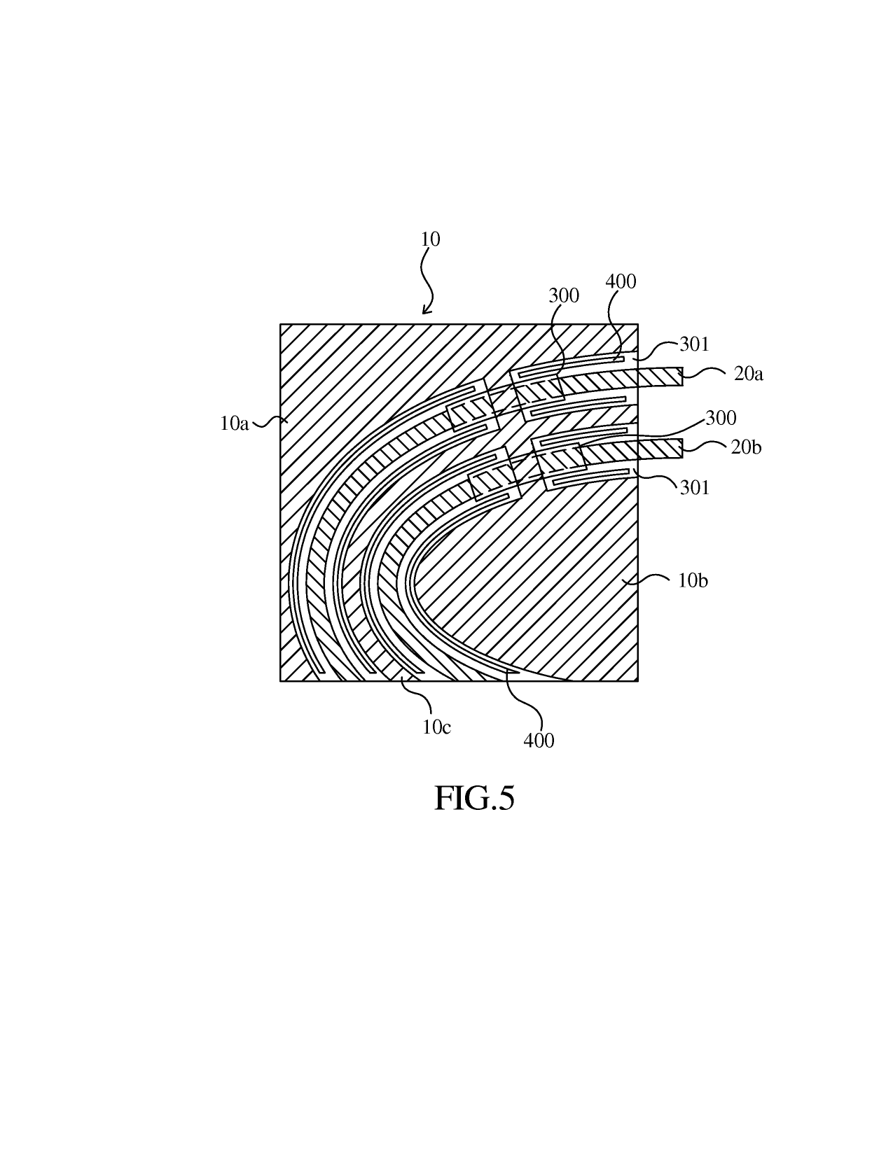

With further reference to FIG. 5, in order to make the surface of the substrate to be more flatter, the projected capacitive touch panel further comprises a plurality of dummy electrodes 400 formed in the gaps 301 without being electrically conducted the first or the second electrodes 10, 20.

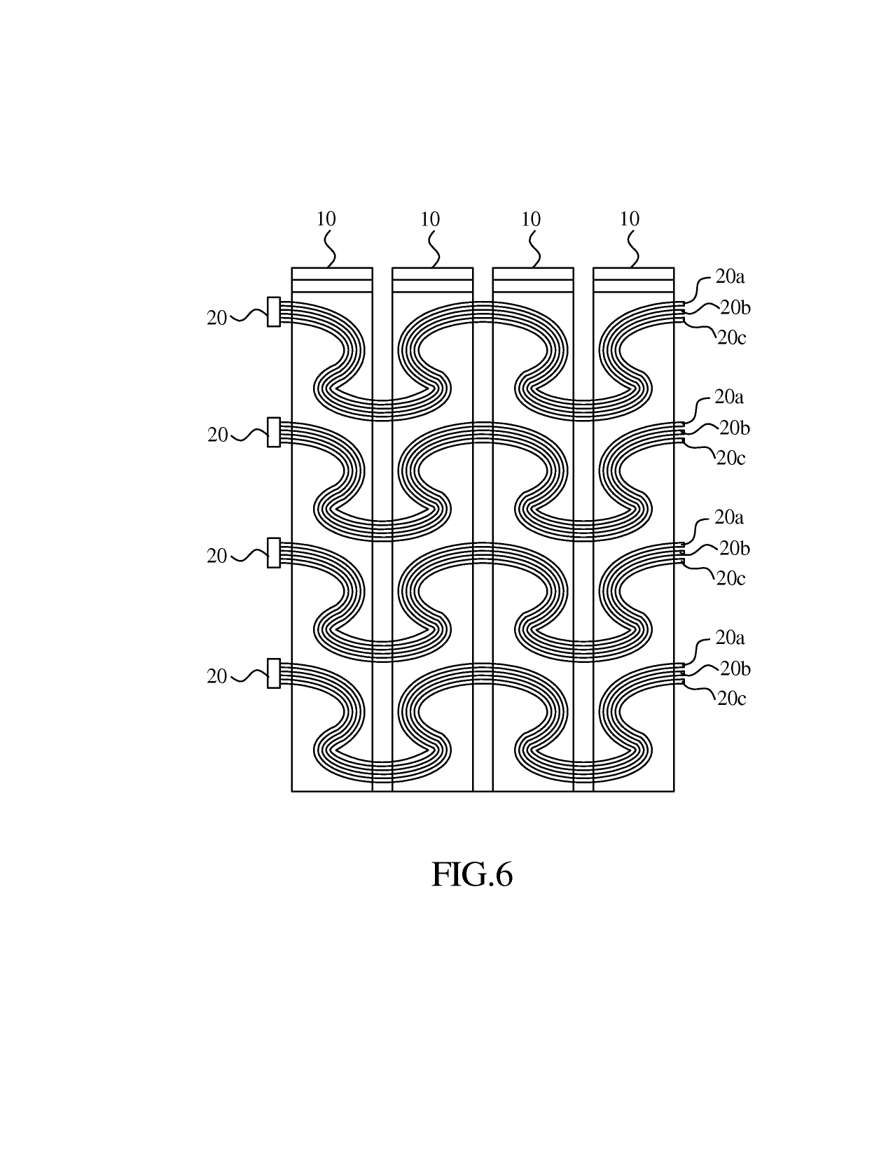

Another embodiment is disclosed in FIG. 6, and the difference of the embodiment is that each second electrode 20 comprises three sensing lines 20a, 20b, 20c. However, it should be noted that the number of the sensing lines of each second electrode is not limited to the disclosure in the embodiments shown in FIGS. 2 and 6.

In conclusion, comparing to the prior art, the present invention reduces the distance left between adjacent electrodes under the same desired sensing-area coverage ratio by using wiggly and thin sensing lines to construct each second electrode. Therefore, the present invention can increase touch sensing accuracy and improve touch sensing effect.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A projected capacitive touch panel comprising:
a plurality of first electrodes being bar shaped, arranged parallel to each other; and
a plurality of second electrodes being wiggly-shaped, separated from each other by a space and including a plurality of sensing lines, and the sensing lines of each second electrodes are spaced from each other by an interval, electrically connected to each other and extend along an oriented direction perpendicular to the length direction of the first electrodes in a wiggly manner.

2. The projected capacitive touch panel as claimed in claim 1, wherein the first electrodes are disposed on a top surface of a first substrate, and the second electrodes are disposed on a bottom surface of a second substrate, wherein the second substrate is opposite to the first substrate.

3. The projected capacitive touch panel as claimed in claim 1, wherein the sensing lines of each second electrode are connected to each other at an end.

4. The projected capacitive touch panel as claimed in claim 1, wherein the sensing lines are connected to each other with multiple conjunctions.

5. The projected capacitive touch panel as claimed in claim 1, wherein the first electrodes and the second electrodes are formed from a transparent conductive material.

6. The projected capacitive touch panel as claimed in claim 1, wherein the first and the second electrodes are formed on a single substrate;

7. The projected capacitive touch panel as claimed in claim 6, wherein
each of the first electrode has a plurality of separated portions that are separated by gaps;
the sensing lines of the second electrodes are formed in the gaps between the adjacent separated portions of the first electrodes; and
the separated portions of each of the first electrode are connected to each other by insulatedly crossing the sensing lines.

8. The projected capacitive touch panel as claimed in claim 7, wherein the separated portions of each of the first electrodes are connected together by crossing the sensing lines with a plurality of bridge members formed therebetween.

9. The projected capacitive touch panel as claimed in claim 7, wherein the projected capacitive touch panel further comprises a plurality of dummy electrodes formed in the gaps without being electrically conducted the first or the second electrodes.
